(19) United States
(12) Patent Application Publication
(10) Pub. No.: US 2011/0212658 A1
(43) Pub. Date: Sep. 1, 2011

(54) FIRE RETARDANT FABRIC

(75) Inventors: Dirk Azer Gerard VANDEPLANCKE, Greensboro, NC (US); Bradley Gaines MARTIN, Burlington, NC (US)

(73) Assignee: BEKAERT TEXTILES USA, INC., Winston-Salem, NC (US)

(21) Appl. No.: 13/032,825

(22) Filed: Feb. 23, 2011

Related U.S. Application Data
(60) Provisional application No. 61/309,072, filed on Mar. 1, 2010.

(51) Int. Cl. B32B 5/02; B05D 5/00; B05D 3/02

(52) U.S. Cl. 442/144; 427/428.01; 427/394

(57) ABSTRACT

The invention relates generally to fabrics and, more particularly, to a fire retardant fabric for covering articles to provide fire retardancy or resistance to open flame ignition sources and the use of said fabrics in open flame resistant mattresses, mattress foundations, upholstered furniture article and other articles filled with resilient cushioning materials that are rendered resistant to open flame and smoldering ignition sources by a consumer/end-user.

The invention relates generally to fabrics and, more particularly, to a fire retardant fabric for covering articles to provide fire retardancy or resistance to open flame ignition sources and the use of said fabrics in open flame resistant mattresses, mattress foundations, upholstered furniture article and other articles filled with resilient cushioning materials that are rendered resistant to open flame and smoldering ignition sources by a consumer/end-user.

### BACKGROUND OF THE INVENTION

The number of injuries and fatalities associated with residential fires in which a mattress, furniture article or other filled item was the first item ignited or where these products exacerbated the fire event has led to regulatory efforts to reduce flammability of mattresses, upholstered furniture and bedclothes used in homes and other occupancies.

The passage of Assembly Bill 603 in the California Legislature of Assembly required that all mattresses and sleep surfaces sold in the State of California since Jan. 1 , 2005, meet an open flame resistance standard described in the state's Technical Bulletin #603 (TB #603). Regulation and enforcement of TB #603 have fallen to the state's Bureau of Home Furnishings and Thermal Insulation (BHFTI).

In addition, the United States Consumer Products Safety Commission (CPSC) recently issued new regulations for further reducing mattress flammability beyond the level required by the Cigarette Ignition Standards as codified in Part 1632 of the Code of Federal Regulations 16 (16 CFR 1632) (or formerly FF 4-72) since the 1970's. This new regulation is codified in Part 1633 of the Code of Federal Regulations 16 (16 CFR 1632) (or formerly FF 4-72) since the 1970's.

The topic of “bedclothes flammability” is also under scrutiny by the State of California under the BHFTI Technical Bulletin #604 which is enactment into law as of July 2005, which is incorporated herein by reference in its entirety.

The new standards for flammability of residential mattresses, upholstered furniture and bedding articles embodied in TB #603, TB #604, the revisions to TB #117, and 16 CFR 1633, have created new demands for performance oriented fire barrier textiles and related materials.

One approach to reducing flammability of mattresses, mattress foundations, upholstered furniture and other filled articles, such as bedclothes, has been to treat fabrics used in their construction with chemical flame retardants. However, these chemical treatments may be objectionable because of distasteful odors which are noticeable when in close contact with the materials, off-gassing obnoxious elements, stiffness of the fabric caused by such treatments, which may compromise the comfort of the finished mattress or mattress foundation, and the potential temporary durability of such treatments, which may compromise the long term protection from open-flame, smoldering ignition and radiant/thermal heat flux sources.

More recently, synthetic Flame Resistant (FR) blends have been developed to address the aforementioned deficiencies of chemical treatment.

US 2005/0204718 discloses a blended yarn designed to provide arc and flame protective properties. The yarn is manufactured from 40% to 70% by weigh of a modacrylic, 5% to 20% by weight of p-aramid and 10% to 40% by weight of m-aramid. The entirely synthetic material is designed to achieve a tensile strength sufficient to be resistant to ‘break-open’ when exposed to an electric arc.

WO 2008/027454 discloses flame resistant fabrics comprising a blend of a synthetic cellulosic and a FR modacrylic. fabrics produced from the fibres are designed to be resistant to electric arc flash and flames.

However, whilst these more recent synthetic FR textiles perform better than the earlier natural fibre based garments there are a number of disadvantages. Firstly, entirely synthetic FR garments are expensive for a number of reasons. The component fibres are typically only available from specialist manufacturers resulting in limited availability. Secondly, the manufacture of these component fibres is complex, requiring a variety of chemical processing steps. Thirdly, FR textiles made entirely from synthetic fibres are typically uncomfortable for the wearer due, in part, to their poor softness and breathability characteristics.

There is therefore a need for a flame retardant fibre blend that may be conveniently and efficiently mass produced for the manufacture of FR garments that satisfy the required national and/or international safety standards whilst being comfortable for the wearer.

Traditionally mattress manufacturers pass CFR Part 1633 by inserting fire barrier materials underneath the decorative mattress fabrics. The fire barrier may be nonwoven, woven, or knitted and optionally chemically treated as mentioned hereinbefore, and such as for example described in US 2009/0149101.

Thus, there remains a need for a unitary, integrally formed fire resistant fabric for applications on upholstered articles and mattresses.

### SUMMARY OF THE INVENTION

The present invention is directed to and provides a fire retardant fabric weighing at least 250 g/m² and comprising a cellulosic fibre in an amount of about 50% to about 80% by weight; in a particular embodiment of about 60% to about 100% by weight; wherein said textile fabric is treated with a solution of an inorganic flame retardant salt, comprising from about ⅕ to about 1/10 of tris(2-chloro-1-(chloromethyl)ethyl)-phosphate when compared to said inorganic salt, and wherein the textile fabric complies with CPSC regulation 16 C.F.R. 1633.

In addition to tris(2-chloro-1-(chloromethyl)ethyl)-phosphate, the inorganic flame retardant salt solution, may further comprise binders, suitable binders include latexes, e.g., acrylic latex, polyurethanes and silicones, and other polymers that are inherently flame retardant, e.g., polyvinyl chloride (PVC).

In a particular embodiment of the present invention, the FR fabric further comprises a synthetic fibre in an amount of about 50% to about 20% by weight; in a particular embodiment of about 40% to about 0% by weight.

As used herein the synthetic fibres used, are meant to include any of the standard yarn types used in the manufacture of fabrics for applications on upholstered articles and mattresses, such as for example selected from the group consisting of polyethylene, polyesters, polypropylene, polyethylene terephtalate, polytrimethyl terephtalate and polyamides. In a particular embodiment the synthetic fibres are selected from polyesters, polypropylene or polyamides; more in particular from polyesters, and/or polypropylene.

As will be apparent to the skilled artisan, the synthetic fibre used in the FR fabric of the present invention is not limited to one single type of fibre but may be blend of two, three, or more synthetic fibres, wherein the total amount of synthetic fibres within the FR fabric of the present invention is from about 50% to about 20% by weight; in a particular embodiment and as exemplified hereinafter, from about 40% to about 0% by weight.

In analogy with the synthetic fibre component, also the cellulosic fibre component in the FR fabric of the present invention is not limited to one single type of cellulosic fibre but may be blend of two, three, or more cellulosic fibres, wherein the total amount of cellulosic fibres within the FR fabric of the present invention is from about 50% to 80% by weight; in a particular embodiment and as exemplified hereinafter, from about 60% to about 80% by weight.

Again any art known cellulosic fibres can be used, including cotton, hemp, flax, jute, linen, ramie and regenerated unsubstituted wood celluloses such as rayon; in particular the cellulosic fibre is selected from cotton or rayon, or a combination thereof.

In view of the FR characteristics of the fabric of the present invention, this material can be used in end uses requiring FR finishes, such as for example protective clothing (e.g., foundry workers apparel and fire fighters uniforms), children's sleepwear, furnishing/upholstery, bedding, carpets, curtains/drapes, and tents. Consequently, the fabric is either woven, knitted or non-woven; in particular woven or knitted.

The inorganic flame retardant salt solution used in the present invention, i.e. comprising from about ⅕ to about 1/10 of tris(2-chloro-1-(chloromethyl)ethyl)-phosphate when compared to said inorganic salt tris(2-chloro-1-(chloromethyl)-ethyl)-phosphate, are typically applied topically at a minimum of 45% wet-pick up, based on fabric weight, by pad finishing or kiss-coating, to yield a final product comprising from about 1.0 to about 3.0 g/m² of the flame retardant composition, i.e. comprising from about 0.8 to about 2.4 g/m² of the inorganic salt and from about 0.2 to about 0.6 g/m² of the phosphorous based FR agent (i.e. tris(2-chloro-1-(chloromethyl)-ethyl)-phosphate).

Notwithstanding the small amount of flame retardant composition present in the final product, the fabrics as described herein pass CPSC regulation 16 C.F.R. 1633, and the even more stringent Market Standard described herein below.

In a further aspect the present invention provides a method for preparing a fabric that complies with CPSC regulation 16 C.F.R. 1633, said method comprising; (a) selecting a fabric weighing at least 250 g/m² and comprising a cellulosic fibre in an amount of about 60% to 100% by weight; (b) treating the fabric with an inorganic flame retardant salt solution comprising from about ⅕ to about 1/10 of tris(2-chloro-1-(chloromethyl)ethyl)-phosphate when compared to said inorganic salt, and wherein the thus treated fabric to yield a fabric that has an acceptable degree of fire resistance to comply with CPSC regulation 16 C.F.R. 1633.

In said method, inorganic flame retardant salt solution is typically applied topically at a minimum of 45% wet-pick up, based on fabric weight, by pad finishing or kiss-coating.

The method may further comprise the step of drying the fabric, such as for example using a tentered oven and/or other known fabric drying means.

In an even further embodiment the manufacturing method may further comprise a dyeing step in conjunction with or prior to the pre-treatment step (b).

The method according to the invention, wherein the inorganic salt is selected from the group consisting of ammonium sulfate, and an ammonium phosphate, such as monoammonium phosphate (MAP), diammonium phosphate (DAP) or Ammonium polyphosphate (APP); in a preferred embodiment the inorganic salt is Ammonium polyphosphate (APP).

The method according to the invention, wherein the fabric further comprising a synthetic fibre in an amount of about 50% to 20% by weight; in a particular embodiment of about 40% to 0% by weight.

The method according to the invention, wherein the cellulosic fibre in the selected fabric is used singularly or wherein two or more kinds of cellulosic fibres are combined.

The method according to the invention, wherein the one, two or more cellulosic fibres are selected from the group consisting of cotton, hemp, flax, jute, linen, ramie and regenerated unsubstituted wood celluloses such as rayon; in particular the cellulosic fibre is selected from cotton or rayon, or a combination thereof.

The method according to the invention, wherein the synthetic fibre comprises one or more of the group selected from polyethylene, polyesters, polypropylene, polyethylene terephtalate, polytrimethyl terephtalate and polyamides.

The method according to the invention, wherein the fabric is woven, knitted or non-woven; in particular woven or knitted.

These and other aspects of the present invention will become apparent to those skilled in the art after a reading of the following description of the preferred embodiment when considered with the drawings.

### DETAILED DESCRIPTION OF THE INVENTION

In the context of the present invention, terms relating to mattresses are defined in conformity with terms as defined by the U.S. Code of Federal Regulations Commercial Standards for the Flammability of Mattresses and Mattress Pads, 16 C. F. R. 1633, and as follows:

“Mattress” means a ticking filled with a resilient material used alone or in combination with other products intended or promoted for sleeping upon.

This definition includes, but is not limited to, adult mattresses, youth mattresses, crib mattresses including portable crib mattresses, bunk bed mattresses, futons, water beds and air mattresses which contain upholstery material between the ticking and the mattress core, and any detachable mattresses used in any item of upholstered furniture such as convertible sofa bed mattresses, corner group mattresses, day bed mattresses, roll-a-way bed mattresses, high risers, and trundle bed mattresses. See Sec. 1632.8 Glossary of terms, for definitions of these items.

“Ticking” means the outermost layer of fabric or related material that encloses the core and upholstery materials of a mattress or mattress pad. A mattress ticking may consist of several layers of fabric or related materials quilted together.

“Core” means the main support system that may be present in a mattress, such as springs, foam, hair block, water bladder, air bladder, or resilient filling.

“Upholstery material” means all material, either loose or attached, between the mattress or mattress pad ticking and the core of a mattress, if a core is present.

“Tape edge” (edge) means the seam or border edge of a mattress or mattress pad.

“Quilted” means stitched with thread or by fusion through the ticking and one or more layers of upholstery material.

“Tufted” means buttoned or laced through the ticking and upholstery material and/or core, or having the ticking and upholstery material and/or core drawn together at intervals by any other method which produces a series of depressions on the surface.”

“Mattress foundation” consists of any surface such as foam, box springs or other, upon which a mattress is placed to lend it support for use in sleeping upon.”

In the event that any of these terms are conflicting in whole or in part, the broadest definition is intended to be used for the purposes of this application for the present invention.

Referring now to the examples hereinafter, the examples are for the purpose of describing a preferred embodiment of the invention and are not intended to limit the invention thereto.

The present invention provides fire barrier fabrics that cover and/or at least partly enclose upholstered furniture articles, mattresses, including articles filled with resilient cushioning materials, and the like, to provide fire retardant and/or fire resistant properties or resistance to open flame ignition sources. More particularly, the fire barrier fabrics are multilayer fabrics having at least two layers and preferably three layers, preferably an outside layer, a filler layer, and a fire barrier layer.

In furniture and other non-mattress applications of the fabric according to the present invention, at least two layers and preferably two layers or lightweight or thin three layers may be used, in particular because drape and conformability to shapes of upholstered furniture require thin, conformable and not so much padded covering material.

Flame or fire retardance or resistance is provided entirely by the fabric of the present invention. Any resistance of the encased article of upholstered furniture seating, mattresses or other cushioned articles to ignition after exposure to an open flame is provided entirely by the fabric itself. Thus testing of an article enclosed or covered with the fabric of the present invention will provide test results associated directly and exclusively with the fabric itself, such as testing in accordance with California Technical Bulletin 133, TB117, ASTM E-1537, NFPA 266 or the methods outlined in the CPSC Staff Draft Standard for Upholstered Furniture Flammability (May 2005), to assess performance of full-scale composite furniture items and mock-ups against open flame ignition sources. Resistance of the encased mattress to ignition after exposure to an open flame may also be determined by full-scale testing in accordance with NFPA 267, 2003 edition, ASTM E 1590, TB 129, TB 603 or the standard 16 CFR 1633. Test protocols of each of these standards are widely available and the entire contents of each test method are incorporated herein by reference. Results of testing a mattress article according to the present invention according to such test protocols typically show a maximum heat release rate of less than 250 kW and a total energy release of less than 40 MJ in the first five minutes of each test. In some embodiments of the present invention, improved protection is provided, as follows: maximum heat release rate of less than 100 kW, total heat release of less that 25 MJ in the first ten minutes of the test and weight loss due to combustion of less than 3 pounds in the first ten minutes of the test.

By way of example and not limitation, multilayer fabric embodiments according to the present invention include single knit including terry velour, double knit, warp knit, and woven fabrics, such as 3-dimensional woven fabrics. Nonwovens are not preferred because they require lamination in a separate step, which increases the handling, processing, and risk of delamination, while reducing the hand and drapability of the fabric, which is undesirable, in particular for upholstered applications. The outside or technical face of the fabric is comprised of standard yarn types used to decorate the face of the fabric, and characterized in having the cellulosic composition as described hereinbefore. The middle filling material component is comprised of textured polyester, nylon yarns or other similar yarns and the inside layer is comprised of standard materials, as long as at the outside layer is treated according to the methods of the present invention. The present invention provides more aesthetically pleasing fibers that feel virtually the same as non-FR fabrics that do not allow a mattress to pass CFR Part 1633.

Further alternative embodiments could be to create a double jersey knit without filling material. When knitting the FR fabric, the composition of the FR fabric layer is actually integrated with and attached structurally to at least one other layer of the multilayer fabric. Thus, the layers are structurally connected and integrated with each other to eliminate the possibility of delamination and maintain the integrity of the FR fabric with respect to any other layers and overall coverage of the article, in particular the outside surface coverage.

The yarns used to create the FR fabrics of the present invention are selected from all available yarn formation techniques and are not limited in size or formation. Yarns may be ring, openend, worsted, airjet, vortex, or any other technique of spinning staple yarns, these yarns may be used by themselves or in addition to flat or textured filament yarns or combined using techniques of plied, plated, corespun, alternated, or any other yarn spinning technique that could be used to combine fibers.

A fire barrier fabric according to the present invention functions to protect a mattress, covered or upholstered furniture article, or padded/cushioned article and/or foundation from fire by forming a char when exposed to an ignition source. A retrofit cover according to the present invention is functional for installation by a consumer, i.e., applied to a completely manufactured product following commercial release, includes a fire barrier fabric that is unitary and integrally formed and including a fire barrier that functions to protect a mattress and/or mattress foundation from fire by forming a char when exposed to an ignition source. In the context of the present invention, the term ‘char’ is defined as a residue formed from material that has been exposed to heat and/or flame, and which is no longer flammable.

The char may be formed from materials that have been incompletely burned and extinguished, or from materials that do not react chemically under conditions found in a fire, and so, are not flammable. Within the context of the present invention the char barrier material mainly consist of the high cellulosic content present within the FR fabric.

Any cellulosic material which includes hydroxy groups can be used in the fabrics of the present invention. Cotton is a preferred cellulosic fibre. Other cellulosic fibers include hemp, flax, jute, bamboo, linen, ramie and regenerated unsubstituted wood celluloses such as rayon. The cellulosic material can be a blend of fibres such as any one or a combination of cotton, bamboo, linen and/or jute. In any event and in order to withstand fire insult, the total amount of cellulosic material present in the fabric should be from about 50% to 80% by weight; in particular from about 60% to about 100% by weight.

According to a further aspect of the present invention, the blend may further comprise a synthetic fibre as defined hereinbefore. The present fibre blend is designed specifically for the manufacture of safety textiles being resistant to heat including extreme heat associated with molten metals, electric discharges and flames. The fabric can be any of a woven, non-woven or knitted fabric and satisfies the aforementioned safety standards. To achieve these objectives the fabric must have an area density of at least 250 g/m², and is treated with flame retardant finishes, i.e. with the reactive phosphorus-based flame retardant tris(2-chloro-1-(chloromethyl)-ethyl)-phosphate.

A variety of application techniques that saturates the fabric with finish can be used to apply the fire retardant solutions. These include immersion, dipping, dripping, cascading, liquor circulation throughout the substrate, padding, kiss rolls, and doctor blades. In a preferred embodiment the finish is applied kiss-coating, padding, foam-coating or hot-melt coating. These techniques may be used alone or in conjunction with vacuum, squeeze rolls, centrifuge, air knives, gravity drainage or other techniques. The application can be done via a continuous or batch method.

The application(s) of the FR agent(s) may be done to the fiber, yarn, or fabric, either before, after, or in conjunction with other manufacturing or processing steps, such as dyeing, winding, finishing, heat setting, tufting or weaving.

For raised surface apparel, or any other apparel that may benefit from a reduction in flammability, the application may be done by any of the above mentioned techniques in fiber, yarn, fabric or garment form. Spraying, foaming, dipping or the “Metered Addition Process” are particularly suitable for garment application. The total amount of solution added to the substrate and the required concentration of FR agent(s) in the solution will be dependent on many factors including the flammability test method, the weight and construction of the substrate, and blend levels of the many possible fibers in a blend.

When the composition is applied to the cellulosic substrate by spray, foam or other low wet pickup methods commonly used for treating fabrics with phosphorus-based flame retardants, the percent by weight of the fire retardant solution which is applied to the cellulosic substrate is typically between about 5 and 100 percent by weight, preferably between about 10 and 50 percent by weight, and more preferably, between about 15 and 30 percent by weight of the fiber to be treated. The use of these methods and types of solutions helps to avoid adding excess water which will have to removed during drying.

For all of these fabric end uses, the chemicals can be applied, for example, by padding at 50-150 percent wet pickup, preferably between 40 and 100 percent wet pickup. However, other application techniques can also be used. Preferably, the phosphorus-based compounds, are present in an aqueous solution, suspension or dispersion. However, other volatile solvents which are inert to the coupling chemistry and in which these materials are soluble or uniformly dispersible can be used.

Additional components can optionally be added to the fire-retardant composition. These include, but are not limited to, other fire retardants, dyes, wrinkle resist agents, foaming agents, buffers, pH stabilizers, fixing agents, stain repellants such as fluorocarbons, stain blocking agents, soil repellants, wetting agents, softeners, water repellants, stain release agents, optical brighteners, emulsifiers, and surfactants.

After the composition is applied and excess water is removed, the material is heated at a sufficient temperature and for a sufficient time to drive off the solvent and/or to react the groups on the cellulosic substrate with the phosphorus-based compound.

Although the temperature required to effectively form the linkages between the FR agent and the hydroxy groups on the cellulosic substrate, would be expected to vary somewhat depending on the nature of the substrate to be treated and the crosslinking agent(s), a typical range of temperatures is between about 20 and 240 [deg.] C., more preferably between 40 and 200 [deg.] C. The temperature is preferably less than would otherwise be required to scorch or melt thermoplastic components of the substrate. Excessive heating can cause yellowing of the substrate fibers, so care should be taken to control the reaction temperatures. Crosslinking agents which will react with the cellulosic material, and, optionally, the phosphorus-based compound, in the wet state can be used to achieve fixation or reaction in the dyeing equipment used to dye cellulosic substrates.

Suitable reaction times are typically between approximately one minute and five hours. However, the reaction times relate in part to the pH of the fire retardant solution. At a pH less than 11 for hydroxy, thiol and amine groups, or greater than 4 for carboxylic acids, cure times are generally longer. However, there appears to be less of a change in the dye shade of dyed goods when a pH greater than 4 is used.

Those of skill in the art can readily determine an appropriate set of reaction conditions (amount of fire retardant solution to add and suitable temperatures and reaction times) to couple the FR agent(s) to the cellulosic substrate.

The invention will be better understood with reference to the following non-limiting examples

### EXAMPLES

### Example 1

### Bekaert Fabrics and Finishing Applied to Different Bed Types

In the following examples the Bekaert FR treatment (hereinafter referred to as TKFB) was compared to a standard fire retardant acrylic latex back coating.

The back coating used in the comparative examples hereinafter consists of approximately 10% fire retardant product, 3% foaming agent, and 2% dispersion agent at a dry add on of 50.0 g/m², such as for example commercially available as eco-FLAM MT-F-227 from the company Devan Chemicals N.V., and hereinafter referred to as Devan MTF 227.

As already mentioned hereinbefore, using the Bekaert FR treatment of the present invention, the finishing only amounts to a dry add on of about 3.0 g/m². As a result the present invention provides more aesthetically pleasing fibers that feel virtually the same as non-FR fabrics that do not allow a mattress to pass CFR Part 1633.

The fabrics used in the comparative tests consisted of;
Sample Numbers 154028 & 157468:
A woven fabric consisting of 73% SPUN RAYON VISCOSE and 27% POLYAMIDE with a total weight of 290.4 g/m²
Sample Numbers 154029 & 157469:
A woven fabric consisting of 62% SPUN RAYON VISCOSE and 5% FILAMENT RAYON VISCOSE and 33% POLYAMID with a total weight of 397.7 g/m².

The aforementioned finished materials, were applied to different bed types and exposed to both Federal Standards, i.e. Total Heat Release First 10 Minutes of Test <15 MJ; Peak Heat Release <200 KW and to a more stringent Market Standard, i.e. Total Heat Release First 10 Minutes of Test <12 MJ; Peak Heat Release <100 KW.

### Box Top With Minimal Latex but High Polyethylene Content:

Box tops with minimal latex but high polyethylene content were used. Standard none-flame retardant (none-FR) fibers were used in the border construction. Box tops were complemented with either the Bekaert FR treated ticks 154028 & 154029, or for comparative purposes the MTF 227 treated ticks 157468 or 157469.

The aforementioned finished materials, were exposed to both Federal Standards, i.e. Total Heat Release First 10 Minutes of Test <15 MJ; Peak Heat Release <200 KW and to a more stringent Market Standard, i.e. Total Heat Release First 10 Minutes of Test <12 MJ; Peak Heat Release <100 KW.

Results are summarized in Table 1 below. All of the box tops finished with the Bekaert treatment (TKFB) and comprising the Bekaert fabrics passed the Fire Retardant tests. To test the strength of this combination, in a further experiment the Bekaert fabrics and TFKB treatment were applied to a latex bed.

TABLE 1
FR testing of box top with minimal latex but high polyethylene content.

| | | | | | Peak | Total | |
|---|---|---|---|---|---|---|---|
| | | | | Where | Heat | Heat | |
| | | | | Sample | Re- | Release | |
| Sample | | | | Fabric | lease | First 10 | PASS/ |
| # | Quality | Pattern | Finish | Used | KW | Min MJ | FAIL |
| 154028 | 91002 | 400014 | TKFB | Gusset | 36.90 | 5.98 | PASS |
| | | | | All | | | |
| | | | | Border | | | |
| 154028 | 91002 | 400014 | TKFB | Gusset | 42.29 | 6.75 | PASS |
| | | | | All | | | |
| | | | | Border | | | |
| 154029 | 90776 | 4065 | TKFB | Gusset | 34 | 4.0 | PASS |
| | | | | All | | | |
| | | | | Border | | | |
| 154029 | 90776 | 4065 | TKFB | Gusset | 34.98 | 4.82 | PASS |
| | | | | All | | | |
| | | | | Border | | | |
| 154029 | 90776 | 4065 | TKFB | Gusset | 33.08 | 4.52 | PASS |
| | | | | All | | | |
| | | | | Border | | | |
| 157468 | 91002 | 400014 | Devan | Gusset | >200 | NA | FAIL |
| | | | MTF 227 | All | | | |
| | | | | Border | | | |
| 157469 | 90776 | 4065 | Devan | Gusset | >200 | NA | FAIL |
| | | | MTF 227 | All | | | |
| | | | | Border | | | |

### Latex Beds:

Latex beds have the highest fuel load and when used without Flame Retardant sock or fibers underneath the sample tick, these beds are the toughest to pass CPSC regulation 16 C.F.R. 1633.

As for the box tops above, standard none-flame retardant (none-FR) fibers were used in the border construction, and the latex beds were complemented with either the Bekaert FR treated ticks 154028 or 154029.

The beds were exposed to both Federal Standards, i.e. Total Heat Release First 10 Minutes of Test <15 MJ; Peak Heat Release <200 KW and to a more stringent Market Standard, i.e. Total Heat Release First 10 Minutes of Test <12 MJ; Peak Heat Release <100 KW.

TABLE 2
FR testing of latex bed

| | | | | | | Total | |
|---|---|---|---|---|---|---|---|
| | | | | | Peak | Heat | |
| | | | | Where | Heat | Release | |
| | | | | Sample | Re- | First | |
| | | | | Fabric | lease | 10 Min | PASS/ |
| Sample # | Quality | Pattern | Finish | Used | KW | MJ | FAIL |
| 154028 | 91002 | 400014 | TKFB | 100% | 30.95 | 2.55 | PASS |
| Comments | | | | All | | | |
| 2 | | | | Over | | | |
| 154028 | 91002 | 400014 | TKFB | Gusset | 33.57 | 3.24 | PASS |
| Comments | | | | All | | | |
| 2 | | | | Border | | | |
| 154028 | 91002 | 400014 | TKFB | Gusset | >200 | 6.33 | FAIL |
| Comments | | | | Only | | | |
| 3 | | | | | | | |
| 154029 | 90776 | 4065 | TKFB | 100% | >200 | 2.36 | FAIL |
| Comments | | | | All | | | |
| 1 | | | | Over | | | |
| 154029 | 90776 | 4065 | TKFB | Gusset | >200 | 3.65 | FAIL |
| Comments | | | | All | | | |
| 1 | | | | Border | | | |
| 154029 | 90776 | 4065 | TKFB | Gusset | 31.72 | 4.54 | PASS |
| Comments | | | | Only | | | |
| 3 | | | | | | | |

### Comments:

This test didn't fail because of the fire resistant characteristics of the TKFB finished fabric 154029, but since the seam at the junction of the mattress and foundation failed. There was flicker at junction of mattress and foundation, with flames penetrating gaps in the thread seam. The flicker stayed in place and at about the 17-minute mark the flame got into the core of the foundation. The filler cloth on the bottom of the mattress is FR. The filler cloth on top of the foundation is non-FR. The flame in the core of the foundation burned through the non-FR filler and eventually breached the FR filler on the bottom of the mattress at the junction of the filler and ticking. The flame thus got into the core of the mattress and the test failed.

Fabric 154028 is less robust than 154029. The flicker still showed at the junction of the mattress and foundation but, instead of staying in place, it slowly moved down the tape edge during the 30-minute test. Thus the flame did not burn into the core of the foundation and the mattresses passed.

When used in the gusset only, the more robust fabric, 154029, passed. The border of these mattresses was BTU “sandpaper” fabric. The flame burned on the border. The FR fiber prevented breach into the core of the mattress or foundation but the latex underneath got very hot. Once hot, the gases in the latex build up then release. Off gassing causes the flame to re-ignite. Over and over the flame would go out then re-ignite. This put a lot of pressure on the junction between the border and the gusset. 154029 took the pressure. 154028 did not. The continued burning eventually breached into the core of the pillow top. Failure soon followed. Thus again, this test didn't fail because of the flame retardant characteristics of the TKFB finished fabric 154028, but due to failure of the material used at the junction between the gusset and the border.

1. A fabric weighing at least 250 g/m² and comprising a cellulosic fibre in an amount of about 60% to about 100% by weight; wherein said textile fabric is treated with is treated with a solution of an inorganic flame retardant salt, comprising from about ⅕ to about 1/10 of tris(2-chloro-1-(chloromethyl)ethyl)-phosphate when compared to said inorganic salt; and wherein the textile fabric complies with CPSC regulation 16 C.F.R. 1633.

2. The fabric according to claim 1, further comprising a synthetic fibre in an amount of about 40% to about 0% by weight.

3. The fabric according to claim 1, wherein the cellulosic fibre is used singularly or wherein two or more kinds of cellulosic fibres are combined.

4. The fabric according to claim 3, wherein the one, two or more cellulosic fibres are selected from the group consisting of cotton, hemp, flax, jute, linen, ramie and regenerated unsubstituted wood celluloses such as rayon; in particular the cellulosic fibre is selected from cotton or rayon, or a combination thereof.

5. The fabric according to claim 2, wherein the synthetic fibre comprises one or more of the group selected from polyethylene, polyesters, polypropylene, polyethylene terephtalate, polytrimethyl terephtalate and polyamides.

6. The fabric according to claim 1, wherein the fabric is woven, knitted or non-woven; in particular woven or knitted.

7. The fabric according to claim 1, wherein the inorganic flame retardant salt solution is applied topically at a minimum of 45% wet-pick up, based on fabric weight.

8. The fabric according to claim 2, wherein the inorganic flame retardant salt solution is applied by pad finishing or kiss-coating.

9. A method for preparing a fabric that complies with CPSC regulation 16 C.F.R. 1633, said method comprising; (a) selecting a fabric weighing at least 250 g/m² and comprising a cellulosic fibre in an amount of about 50% to about 80% by weight; (b) treating the fabric with an inorganic flame retardant salt solution comprising from about ⅕ to about 1/10 of tris(2-chloro-1-(chloromethyl)ethyl)-phosphate when compared to said inorganic salt, and wherein the thus treated fabric to yield a fabric that has an acceptable degree of fire resistance to comply with CPSC regulation 16 C.F.R. 1633.

10. The method according to claim 9, the inorganic flame retardant salt solution is applied by pad finishing or kiss-coating.

11. The method according to claim 10, further comprising the step of drying the fabric, such as for example using a tentered oven and/or other known fabric drying means.

12. The method according to claim 10, further comprising a dyeing step in conjunction with or prior to the treatment step (b).

13. The method according to claim 9, wherein the inorganic salt is selected from the group consisting of ammonium sulfate, and an ammonium phosphate, such as monoammonium phosphate (MAP), diammonium phosphate (DAP) or ammonium polyphosphate (APP); in a preferred embodiment the inorganic salt is ammonium polyphosphate (APP).

14. The method according to claim 9, wherein the inorganic flame retardant salt solution is applied topically at a minimum of 45% wet-pick up, based on fabric weight.

15. The method according to claim 9, wherein the fabric further comprising a synthetic fibre in an amount of about 40% to about 0% by weight.

16. The method according to claim 9, wherein the cellulosic fibre in the selected fabric is used singularly or wherein two or more kinds of cellulosic fibres are combined.

17. The method according to claim 16, wherein the one, two or more cellulosic fibres are selected from the group consisting of cotton, hemp, flax, jute, linen, ramie and regenerated unsubstituted wood celluloses such as rayon; in particular the cellulosic fibre is selected from cotton or rayon, or a combination thereof.

18. The method according to claim 15, wherein the synthetic fibre comprises one or more of the group selected from polyethylene, polyesters, polypropylene, polyethylene terephtalate, polytrimethyl terephtalate and polyamides.

19. The method according to claim 9, wherein the fabric is woven, knitted or non-woven; in particular woven or knitted.
